(19) United States
(12) Patent Application Publication
(10) Pub. No.: US 2026/0260990 A1
(43) Pub. Date: Sep. 3, 2026

(54) LATTICE BATTERY CELL SEPARATOR

(71) Applicants: FCA US LLC, Auburn Hills, MI (US); Stellantis Auto SAS, Poissy (FR)

(72) Inventors: Michael Wiland, Auburn Hills, MI (US); Zachary Cook, Auburn Hills, MI (US)

(21) Appl. No.: 19/066,701

(22) Filed: Feb. 28, 2025

(51) Int. Cl. H01M 50/242; H01M 10/613; H01M 10/625; H01M 50/204; H01M 50/249; H01M 50/291; H01M 50/293

(52) U.S. Cl. CPC H01M 50/242; H01M 10/613; H01M 10/625; H01M 50/204; H01M 50/249; H01M 50/291; H01M 50/293

(57) ABSTRACT

A battery pack assembly includes a battery module having: first and second cells, and a first spacer. The first cell includes a first sidewall and a second sidewall. The second cell includes a first sidewall and a second sidewall, the second cell arranged adjacent to the first cell and defining a gap between the second sidewall of the first cell and the first sidewall of the second cell. The first spacer is positioned between the first and second cells at the gap, the first spacer including a spacer body having a frame and a plurality of extension portions. The spacer inhibits swelling of the second sidewall of the first cell and the first sidewall of the second cell toward each other and redistribute expansion of the second sidewall of the first cell and the first sidewall of the second cell thereby facilitating flow of cooling liquid at the first gap.

### FIELD

The present application generally relates to electrified vehicles and, more particularly, to a battery cell separator or spacer configured between adjacent battery cells in an immersive cooling battery pack architecture.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack or module assembly that includes a housing that houses a plurality of battery cells. When the battery system is charged and discharged, the lithium inside of the respective cells is plated and stripped from the anode and cathode. This results in a physical deformation of the cell, commonly known as cell breathing. When cells breathe, they can come in contact with each other. If the cells are cooled using an immersive cooling architecture, then fluid needs to be in constant contact with all surfaces of the cell. In this regard, there is a requirement for adequate spacing between the cells to allow for minimal pressure losses and even flow distribution for the cooling fluid throughout the battery module assembly. In some existing examples, a thermal interface material keeps adjacent cells separated and conducts the heat from the cells down to a cooling plate at the bottom of the battery pack. In other existing examples, the battery packs are designed with enough spacing between adjacent cells to allow them to swell and not touch. Such existing solutions are unsatisfactory and inefficient. Accordingly, while such immersive cooling battery module assemblies do work well for their intended purpose, there is a desire for improvement in the relevant art.

### SUMMARY

According to one example aspect of the invention, a battery pack assembly includes a battery module that comprises: a first cell, a second cell, and a first spacer. The first cell includes a first sidewall and a second sidewall. The second cell includes a first sidewall and a second sidewall, the second cell arranged adjacent to the first cell and defining a gap between the second sidewall of the first cell and the first sidewall of the second cell. The first spacer is positioned between the first and second cells at the gap, the first spacer including a spacer body having a frame and a plurality of extension portions. The plurality of extension portions inhibit swelling of the second sidewall of the first cell and the first sidewall of the second cell toward each other and redistribute expansion of the second sidewall of the first cell and the first sidewall of the second cell thereby facilitating flow of cooling liquid through the first spacer at the first gap.

In some implementations, the plurality of extension portions inhibit swelling at a center of the second sidewall of the first cell and at a center the first sidewall of the second cell.

In some implementations, the plurality of extension portions redistribute the expansion from (i) the center of the second sidewall of the first cell and at the center the first sidewall of the second cell; and (ii) toward a perimeter of the second sidewall of the first cell and toward a perimeter of the first sidewall of the second cell.

In some implementations, the extension portions are in the form of pegs.

In some implementations, the pegs are cylindrical.

In additional aspects, the frame comprises a lattice having (i) a plurality of outer arms that connect between extension portions arranged on an outboard portion of the frame; and (ii) a plurality of inner arms that connect between extension portions arranged on an inboard portion of the frame.

In additional features, the first spacer is formed of plastic.

In additional arrangements, the first spacer is formed of injection molding.

In some examples, the first spacer is formed of three-dimensional printing.

In implementations, the first gap is between 3 mm and 5 mm.

In other examples, the swelling comprises an expansion of the second sidewall of the first cell in a convex shape.

In additional examples, the swelling further comprises an expansion of the first sidewall of the second cell in a convex shape.

In other implementations, the swelling is centrally located on the second sidewall of the first cell and the first sidewall of the second cell.

In additional examples, the battery module further comprises: a third cell including a first sidewall and a second sidewall, the third cell arranged adjacent to the second cell and defining a second gap between the second sidewall of the second cell and the first sidewall of the third cell; and a second spacer positioned between the second and third cells at the second gap, the third spacer including a spacer body having a frame and a plurality of extension portions; wherein the plurality of extension portions of the second spacer inhibit swelling of the second sidewall of the second cell and the first sidewall of the third cell toward each other and redistribute expansion of the second sidewall of the second cell and the first sidewall of the third cell thereby facilitating flow of cooling liquid through the second spacer at the second gap.

In other implementations, the plurality of extension portions of the second spacer inhibit swelling at a center of the second sidewall of the second cell and at a center the first sidewall of the third cell.

In other examples, the plurality of extension portions of the second spacer redistribute the expansion from (i) the center of the second sidewall of the second cell and at the center of the first sidewall of the third cell; and (ii) toward a perimeter of the second sidewall of the second cell and toward a perimeter of the first sidewall of the third cell.

In additional examples, the extension portions of the second spacer are in the form of pegs.

In other implementations, the second spacer is formed of plastic.

In other examples, the second spacer is formed of injection molding.

In other examples, the second spacer is formed of three-dimensional printing.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly that incorporates spacers between adjacent cells according to various principles of the present application;

FIG. 2 is a front perspective view of a collection of battery cells of the battery pack assembly of FIG. 1 and having a spacer positioned between adjacent cells according to various principles of the present application, the battery cells shown in an unswollen state;

FIG. 3 is a side view of the collection of battery cells of FIG. 2;

FIG. 4 is a front perspective view of the collection of battery cells shown in FIG. 1 with one cell removed to illustrate one of the spacers;

FIG. 5 is a side view of a collection of battery cells of the battery pack assembly of FIG. 1 and having a spacer positioned between adjacent cells, the battery cells shown in a swollen state whereby the spacers redistribute the expansion of cell sidewalls for the purpose of maintaining flow channel height for the cooling liquid according to various principles of the present application; and

FIG. 6 is a front perspective view of a spacer constructed in accordance to one example of the present disclosure.

### DESCRIPTION

As discussed above, when the battery system is charged and discharged, the lithium inside of the cell is plated and stripped from the anode and cathode. This results in a physical deformation of the cell, commonly known as cell breathing. When cells breathe, they can come in contact with each other. If the cells are cooled using an immersive cooling architecture, then fluid needs to be in constant contact with all surfaces of the cell. In this regard, there is a requirement for adequate spacing between the cells to allow for minimal pressure losses and even flow distribution for the fluid throughout the battery module assembly.

Existing solutions of using a cold plate do not allow for optimal cooling of the battery cells. It also does not allow for any suppression of thermal runaway of the cells via the cooling fluid. Immersive cooling allows for suppression of thermal runaway but requires more space between the cells to allow for breathing, resulting in poor fill factor and decreased energy density for the battery pack.

The present disclosure provides a spacer configuration that allows for the minimum space between adjacent cells to be achieved and further allows for adequate flow rate and distribution of the coolant. This increases the energy density of the battery while still enabling immersive cooling of the battery cells. The spacer is comprised of a spacer body having a distribution of small pegs that keep the cells from contacting each other. The small pegs are connected via a thin lattice so that the spacer can be inserted as one piece while covering the least amount of surface area of the adjacent cells. Further, the spacer still provides the most open flow paths for the dielectric cooling fluid to flow between adjacent cells. In one arrangement, the small pegs are spaced evenly so they can evenly distribute the stress load that will be applied by the adjacent cells'swelling. The pegs of the spacer redistribute the expansion of cell sidewalls for the purpose of maintaining flow channel height for the cooling liquid.

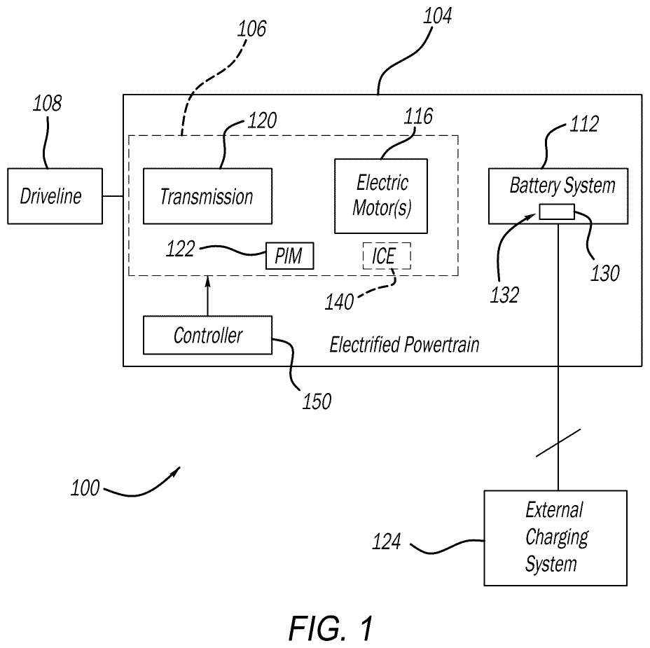

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. In some examples, the electrified powertrain 104 can be a hybrid powertrain that additionally includes an internal combustion engine 140. A controller 150 can provide various inputs to the EDM 106 related to selectively switching power inputs between the electric motors 116 and the ICE 140.

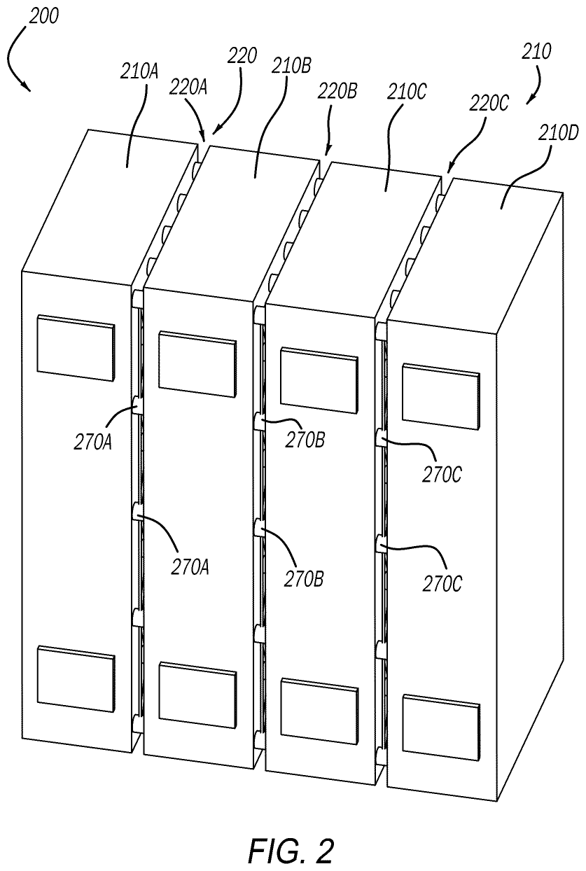

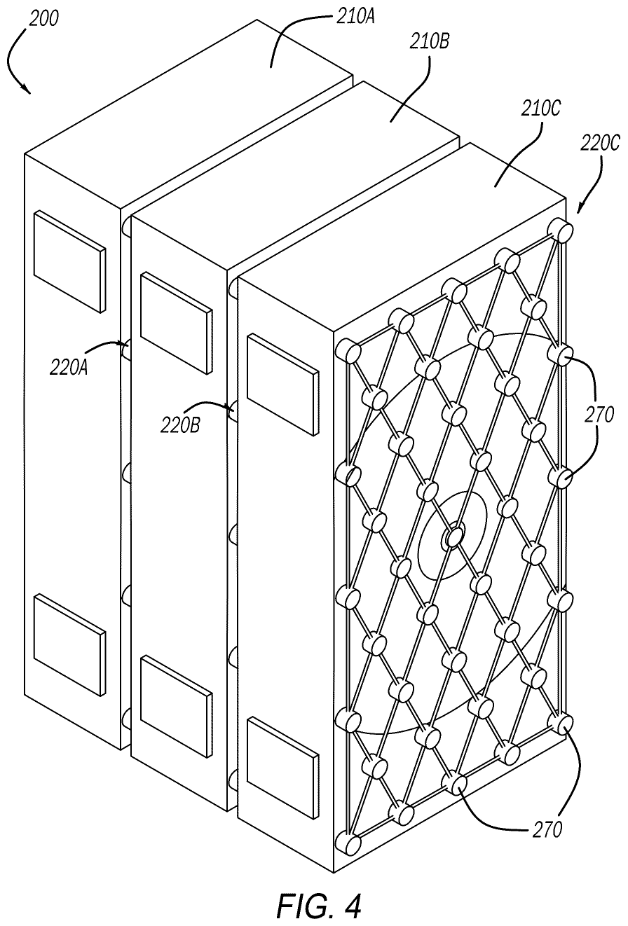

Turning now to FIGS. 2-6, the battery pack assembly 130 constructed in accordance to various examples of the present disclosure will be described. The battery pack assembly 130 generally includes a battery module assembly 132 that generally houses a plurality of respective cells collectively identified at 210 and individually identified at reference numerals 210A, 210B, 210C and 210D. It will be appreciated that while only four cells are shown in FIG. 2 for illustrative purposes, a battery module assembly 132 can be configured with less or more cells. Between adjacent cells 210 are spacers, collectively identified at reference numeral 220 and individually identified at reference numerals 220A, 220B, and 220C.

As will become appreciated from the following discussion, the battery pack assembly 130 is configured for immersive cooling applications. In immersive cooling, a cooling liquid L surrounds all of the cells 220 to provide a cooling effect. As mentioned above, when the cells 220 swell, the gap between the cells is reduced, at the area of swelling, potentially reducing flow of the cooling liquid L between the cells 220. When the flow path of the cooling liquid L is inhibited by the swollen cells, cooling efficiency is reduced.

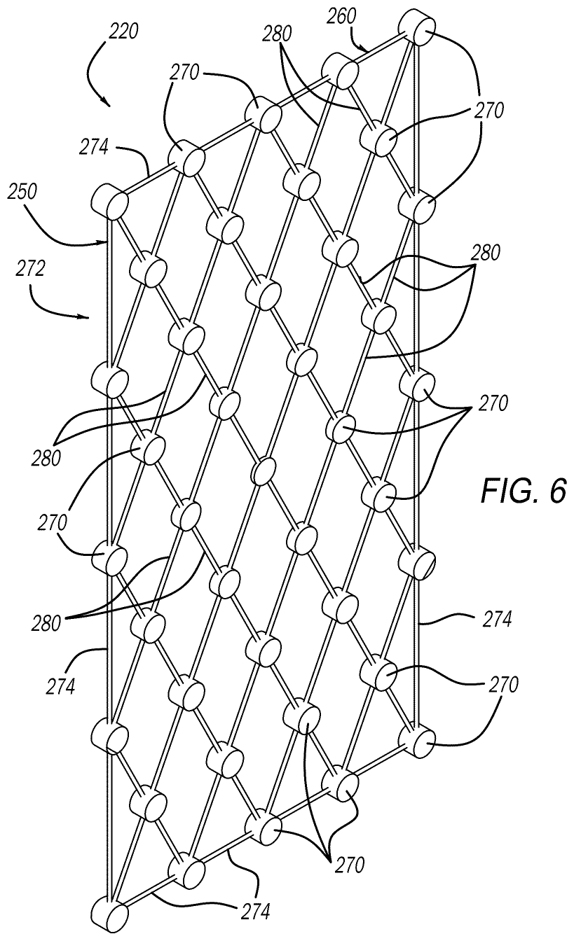

With particular reference now to FIG. 6, a spacer 220 will be described. The spacer 220 generally includes a spacer body 250 having a frame 260 and a plurality of extension portions or pegs 270. In the example shown, the frame 260 is in the form of a lattice 272 having a plurality of outer arms 274 that connect between outboard pegs 270 and plurality of inner arms 280 that connect between adjacent inboard pegs 270. The arrangement of the pegs 270 and configuration of the lattice 272 is merely exemplary. In this regard, while the spacer 220 shown has extension portions 270 represented by pegs having a cylindrical geometry that promote cooling liquid L flow therearound, the extension portions 270 can have other shapes and distributed in alternate quantities.

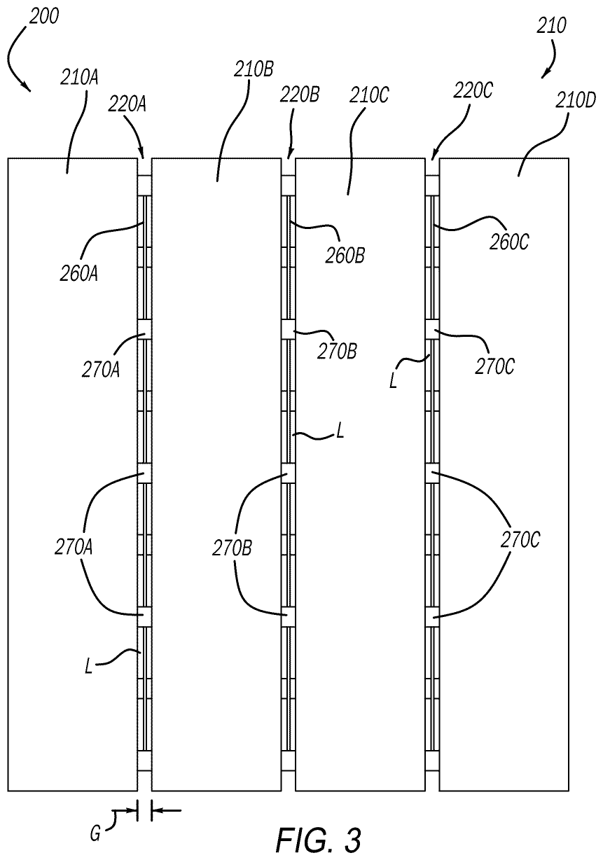

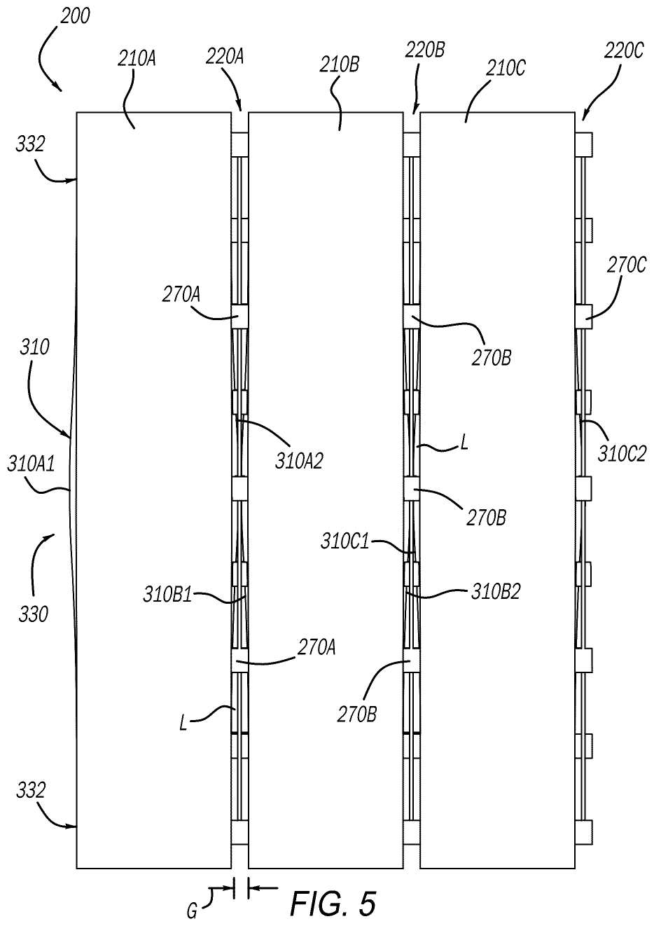

With reference now to FIG. 5, a side perspective view of a collection of battery cells 210 of the battery pack assembly 130 of FIG. 1. The spacers 220A, 220B are shown positioned between adjacent cells 210A, 210B and 210C. The spacers 220 can be located in a gap G (FIG. 3) defined between adjacent cells. By way of non-limiting example, the gap can be about 3-5 mm. The battery cells 210A, 210B and 210C are shown in a swollen state. The cells 210 tend to swell outwardly at the center (the center top to bottom and the center front to back). The swollen state is represented by swollen or convex sidewalls, collectively identified at reference numeral 310. In particular, cell 210A has swollen outer sidewalls 310A1 and 310A2. Similarly, cell 210B has swollen outer sidewalls 310B1 and 310B2. Cell 210C has swollen sidewalls 310C1 and 310C2.

As shown, the pegs 270A of the spacer 220A inhibit swelling of the sidewall 310A2 of cell 210A and the sidewall 310B1 of the cell 210B. In other words, the pegs 270A cooperate to minimize the maximum amount of swelling of the adjacent sidewalls 310A2 and 310B1 toward each other. As a result, the reduction in flow of cooling liquid L between adjacent cells 210A and 210B is mitigated. Similarly, the pegs 270B of the spacer 220B inhibit swelling of the sidewall 310B2 of cell 210B and the sidewall 310C1 of the cell 210C.

As explained above, the pegs 270B cooperate to minimize the swelling of the adjacent sidewalls 310B2 and 310C1 toward each other. As a result, the reduction in flow of cooling liquid L between adjacent cells 210B and 210C is mitigated. It is appreciated that this pattern repeats and each spacer 220 inhibits swelling of adjacent cell sidewalls toward each other to inhibit any blocking of flow of the cooling liquid L between adjacent cells 210. Because the swelling tends to occur around the center of the cells 210, generally identified at reference 330, the pegs 270 on the spacers 220 act to redistribute any necessary swelling from around the center 330 to outboard locations, generally identified at reference 332 on the cell 210 (toward a perimeter and away from the center both up down and forward backward). The spacers 220 therefore redistribute the swelling more uniformly across faces of the sidewalls 310 of the cells 210, rather than allowing the swelling to occur exclusively around the center 330.

The spacer 220 is formed of durable, lightweight material compatible with dielectric fluid. In examples, the spacer 220 is formed of plastic. The spacer 220 can be formed by any manufacturing process such as, but not limited to injection molding, and three dimensional printing. In examples, the pegs 270 are distributed across the spacer 220 to spread out the force distribution from the swelling cell sidewalls 310 in a way that achieves the minimum pressure drop between adjacent cells 210. The pegs 270 of the spacer 220 redistribute the expansion of cell sidewalls for the purpose of maintaining flow channel height for the cooling liquid L. The lattice 272 acts to couple all the pegs 270 in a manner that allows easy assembly of the spacer 220 as a single unit between adjacent cells 210.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery pack assembly comprising:
a battery module assembly configured for immersive cooling, the battery module comprising:
a first cell including a first sidewall and a second sidewall;
a second cell including a first sidewall and a second sidewall, the second cell arranged adjacent to the first cell and defining a gap between the second sidewall of the first cell and the first sidewall of the second cell; and
a first spacer positioned between the first and second cells at the gap, the first spacer including a spacer body having a frame and a plurality of extension portions;
wherein the plurality of extension portions inhibit swelling of the second sidewall of the first cell and the first sidewall of the second cell toward each other and redistribute expansion of the second sidewall of the first cell and the first sidewall of the second cell thereby facilitating flow of cooling liquid through the first spacer at the first gap.

2. The battery pack assembly of claim 1, wherein the plurality of extension portions inhibit swelling at a center of the second sidewall of the first cell and at a center the first sidewall of the second cell.

3. The battery pack assembly of claim 2, wherein the plurality of extension portions redistribute the expansion from (i) the center of the second sidewall of the first cell and at the center the first sidewall of the second cell; and (ii) toward a perimeter of the second sidewall of the first cell and toward a perimeter of the first sidewall of the second cell.

4. The battery pack assembly of claim 1, wherein the extension portions are in the form of pegs.

5. The battery pack assembly of claim 4, wherein the pegs are cylindrical.

6. The battery pack assembly of claim 1, wherein the frame comprises a lattice having (i) a plurality of outer arms that connect between extension portions arranged on an outboard portion of the frame; and (ii) a plurality of inner arms that connect between extension portions arranged on an inboard portion of the frame.

7. The battery pack assembly of claim 1, wherein the first spacer is formed of plastic.

8. The battery pack assembly of claim 7, wherein the first spacer is formed of injection molding.

9. The battery pack assembly of claim 7, wherein the first spacer is formed of three-dimensional printing.

10. The battery pack assembly of claim 1, wherein the first gap is between 3 mm and 5 mm.

11. The battery pack assembly of claim 1, wherein the swelling comprises an expansion of the second sidewall of the first cell in a convex shape.

12. The battery pack assembly of claim 11, wherein the swelling further comprises an expansion of the first sidewall of the second cell in a convex shape.

13. The battery pack assembly of claim 12, wherein the swelling is centrally located on the second sidewall of the first cell and the first sidewall of the second cell.

14. The battery pack assembly of claim 1, wherein the battery module further comprises:
a third cell including a first sidewall and a second sidewall, the third cell arranged adjacent to the second cell and defining a second gap between the second sidewall of the second cell and the first sidewall of the third cell; and
a second spacer positioned between the second and third cells at the second gap, the third spacer including a spacer body having a frame and a plurality of extension portions;
wherein the plurality of extension portions of the second spacer inhibit swelling of the second sidewall of the second cell and the first sidewall of the third cell toward each other and redistribute expansion of the second sidewall of the second cell and the first sidewall of the third cell thereby facilitating flow of cooling liquid through the second spacer at the second gap.

15. The battery pack assembly of claim 14, wherein the plurality of extension portions of the second spacer inhibit swelling at a center of the second sidewall of the second cell and at a center the first sidewall of the third cell.

16. The battery pack assembly of claim 15, wherein the plurality of extension portions of the second spacer redistribute the expansion from (i) the center of the second sidewall of the second cell and at the center of the first sidewall of the third cell; and (ii) toward a perimeter of the second sidewall of the second cell and toward a perimeter of the first sidewall of the third cell.

17. The battery pack assembly of claim 14, wherein the extension portions of the second spacer are in the form of pegs.

18. The battery pack assembly of claim 14, wherein the second spacer is formed of plastic.

19. The battery pack assembly of claim 18, wherein the second spacer is formed of injection molding.

20. The battery pack assembly of claim 18, wherein the first spacer is formed of three-dimensional printing.
